(19) United States
(12) Patent Application Publication
(10) Pub. No.: US 2019/0028718 A1
(43) Pub. Date: Jan. 24, 2019

(54) VIDEO ENCODING DEVICE, VIDEO ENCODING METHOD, VIDEO DECODING DEVICE, AND VIDEO DECODING METHOD

(71) Applicant: FUJITSU LIMITED, Kawasaki-shi (JP)

(72) Inventor: Junpei KOYAMA, Shibuya (JP)

(73) Assignee: FUJITSU LIMITED, Kawasaki-shi (JP)

(21) Appl. No.: 16/009,328

(22) Filed: Jun. 15, 2018

(30) Foreign Application Priority Data
Jul. 19, 2017 (JP) 2017-140339

(51) Int. Cl. H04N 19/182; H04N 19/176; H04N 19/46; H04N 19/44; H04N 19/186

(52) U.S. Cl. CPC H04N 19/182; H04N 19/176; H04N 19/186; H04N 19/44; H04N 19/46

(57) ABSTRACT

A device that encodes an encoding-target picture included in video data includes a processor configured to generate a pixel value map representing a spatial distribution of pixel values of an encoding-target block from among a plurality of blocks obtained by dividing the encoding-target picture, add a flag to a pixel having a value identical to a value of a corresponding pixel in the pixel value map from among pixels included in the encoding-target block, and include, in encoded data of the video data, information representing the pixel value map and the flag added to the pixel having a value identical to a value of a corresponding pixel in the pixel value map from among the pixels included in the encoding-target block.

### CROSS-REFERENCE TO RELATED APPLICATION

This application is based upon and claims the benefit of priority of the prior Japanese Patent Application No. 2017-140339, filed on Jul. 19, 2017, the entire contents of which are incorporated herein by reference.

### FIELD

The embodiments discussed herein are related to a video encoding device, a video encoding method, a video decoding device, and a video decoding method.

### BACKGROUND

Video data typically has a large amount of data. In particular, video data based on a standard for a technique using a very large number of pixels such as “4K” or “8K” may have a very large amount of data. Accordingly, a device treating video data performs compression encoding on video data when transmitting the video data to a different device or storing the video data in a storage device. Examples of representative standards for encoding videos include Moving Picture Experts Group phase 2 (MPEG-2), MPEG-4, and H.264 MPEG-4 Advanced Video Coding (MPEG-4 AVC/H.264), which were developed by International Standardization Organization/International Electrotechnical Commission (ISO/IEC). JCTVC, conjointly organized by ITU-T and ISO/IEC, is also developing High Efficiency Video Coding (HEVC, MPEG-H/H.265) as a new standard.

Further, JCTVC is discussing, as expansion of HEVC, the development of Screen Contents Coding (SCC), which is an encoding standard for screen content. SCC is an encoding standard supposed to be applied to for example the encoding of artificial images such as an image displayed on the desktop of a computer, and its application to for example purposes including the encoding of images transmitted from a server to a thin client terminal is being discussed.

In more detail, a screen image has features that natural images do not have. For example, a screen image typically has higher spatial correlation of color components and uses fewer colors than a natural image.

In view of this, SCC is discussing the introduction of a technique referred to as palette encoding (see Non-Patent Document 1 for example). In palette encoding, colors that often appear are registered as color entries in a color table referred to as a palette table, and a different index is assigned to each of the registered color entries. Each pixel included in a block as an encoding target is represented by the index of the same color entry as the value (including the color component) of that pixel, and thereby the block is encoded.

Non-Patent Document 1: R. Joshi, et al. “High Efficiency Video Coding (HEVC) Screen Content Coding: Draft 2”, JCTVC-51005, 18th JCT-VC Meeting, Sapporo, J P, Jun. 30-Jul. 9, 2014

### SUMMARY

According to an aspect of the embodiments, a video encoding device that encodes an encoding-target picture included in video data includes a processor configured to generate a pixel value map representing a spatial distribution of pixel values of an encoding-target block from among a plurality of blocks obtained by dividing the encoding-target picture, add a flag to a pixel having a value identical to a value of a corresponding pixel in the pixel value map from among pixels included in the encoding-target block, and include, in encoded data of the video data, information representing the pixel value map and the flag added to the pixel having a value identical to a value of a corresponding pixel in the pixel value map from among the pixels included in the encoding-target block.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 schematically illustrates a configuration of a video encoding device according to an embodiment;

FIG. 2 illustrates an example of the division of a picture based on HEVC;

FIG. 3 illustrates an example of map encoding performed by referring to a pixel value map;

FIG. 4 illustrates an operation flowchart for a video encoding process;

FIG. 5 schematically illustrates a configuration of a video decoding device according to an embodiment;

FIG. 6 illustrates an operation flowchart for a video decoding process; and

FIG. 7 illustrates a configuration of a computer that operates as a video encoding device or a video decoding device.

### DESCRIPTION OF EMBODIMENTS

In palette encoding for example, a method is being discussed, in which when a pixel as an encoding target and the pixel adjacent to the pixel as the encoding target on the upper side have identical indexes, the index of the pixel adjacent on the upper side is used as the index of the pixel as the encoding target. When the index of the adjacent pixel is utilized as the index of the pixel as the encoding target, a flag (which will hereinafter be referred to as a copy flag for the sake of convenience of the explanations) specifies such utilization. Because the expression of a copy flag uses at most one bit, using indexes of adjacent pixels of the same color that are vertically continuing leads to higher encoding efficiency.

In palette encoding, a method is also being discussed, in which a run length is used to specify the number of pixels having identical indexes continuing in the order of a raster scan. This method makes it possible to specify, by run length, identical indexes continuing over a plurality of pixels, improving the encoding efficiency for a case where the same color continues horizontally.

However, a screen image may include a picture involving a diagonal gradation. It is not possible to utilize indexes of vertically adjacent pixels or to use a run length to specify the indexes of a plurality of horizontal pixels, sometimes leading to failure in improving the encoding efficiency even when palette encoding is used.

This results in a demand that a video encoding device be provided that can improve the encoding efficiency even when video data includes a picture involving a diagonal gradation.

Hereinafter, explanations will be given for a video encoding device and a video decoding device by referring to the drawings. This video encoding device employs a palette encoding method. According to a prescribed rule, this video encoding device generates a pixel value map representing a spatial distribution of pixel values of an encoding-target block, and includes, in the encoded data, a flag indicating whether the value of each pixel in the encoding-target block is identical to the value of the corresponding pixel in the pixel value map. Note that a pixel value represents not only the luminance but also the color component. Further, the video encoding device specifies the index of a color entry, registered in the palette table, that is identical to a pixel in an encoding-target block having a value different from the value of the corresponding pixel in the pixel value map. Thereby, the video encoding device improves the encoding efficiency also for a picture involving a diagonal gradation. Note hereinafter that a method in which an encoding-target block is encoded by referring to a pixel value map will be referred to as a map encoding method. An encoding mode employing a map encoding method will be referred to as a map encoding mode. Similarly, an encoding mode employing a palette encoding method will be referred to as a palette encoding mode.

The video encoding device in the present embodiment encodes video data in accordance with H.265 for the division of a picture, inter-predictive encoding, and intra-predictive encoding. However, the video encoding device may encode video data in accordance with a different encoding standard to which palette encoding method can be applied.

Also, a picture may be a frame or may be a field. A frame is one still image in video data, and a field is a still image obtained by extracting data of either odd-numbered lines or even-numbered lines from a frame.

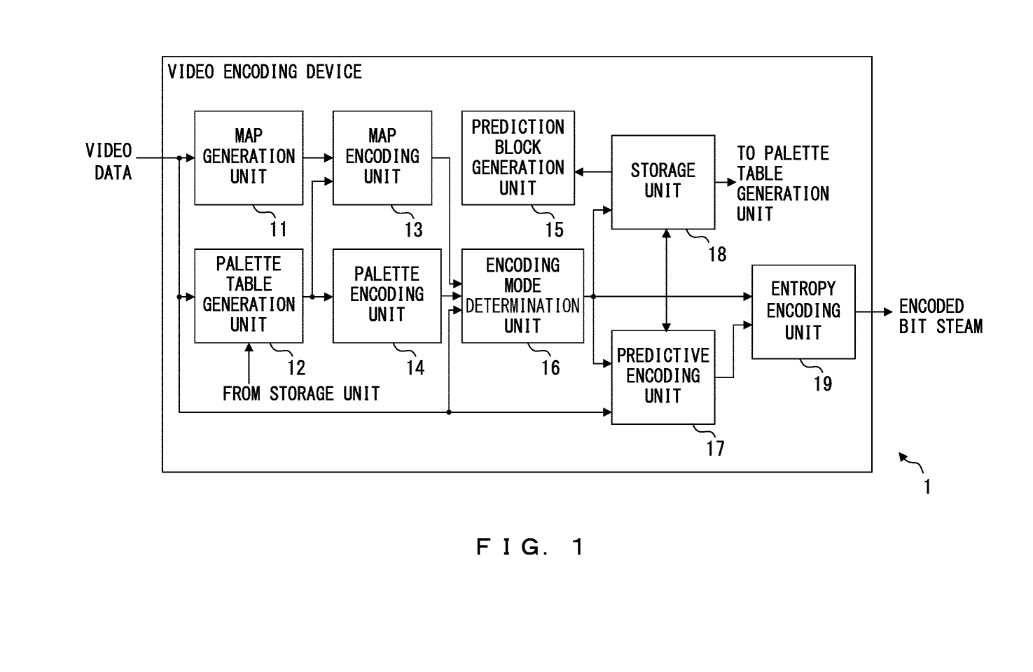

FIG. 1 schematically illustrates a configuration of a video encoding device according to an embodiment. A video encoding device 1 includes a map generation unit 11, a palette table generation unit 12, a map encoding unit 13, a palette encoding unit 14, a prediction block generation unit 15, an encoding mode determination unit 16, a predictive encoding unit 17, a storage unit 18, and an entropy encoding unit 19.

Each of the units belonging to the video encoding device 1 is formed as a separate circuit. Alternatively, the units belonging to the video encoding device 1 may be mounted on the video encoding device 1 as one or a plurality of integrated circuits in which circuits corresponding to the units are integrated. Further, the units belonging to the video encoding device 1 may be function modules that are implemented by a computer program executed on one or a plurality of processors included in the video encoding device 1.

In HEVC according to which the video encoding device 1 operates, each picture included in video data is divided in a plurality of steps. Thus, the division of a picture according to HEVC will first be explained.

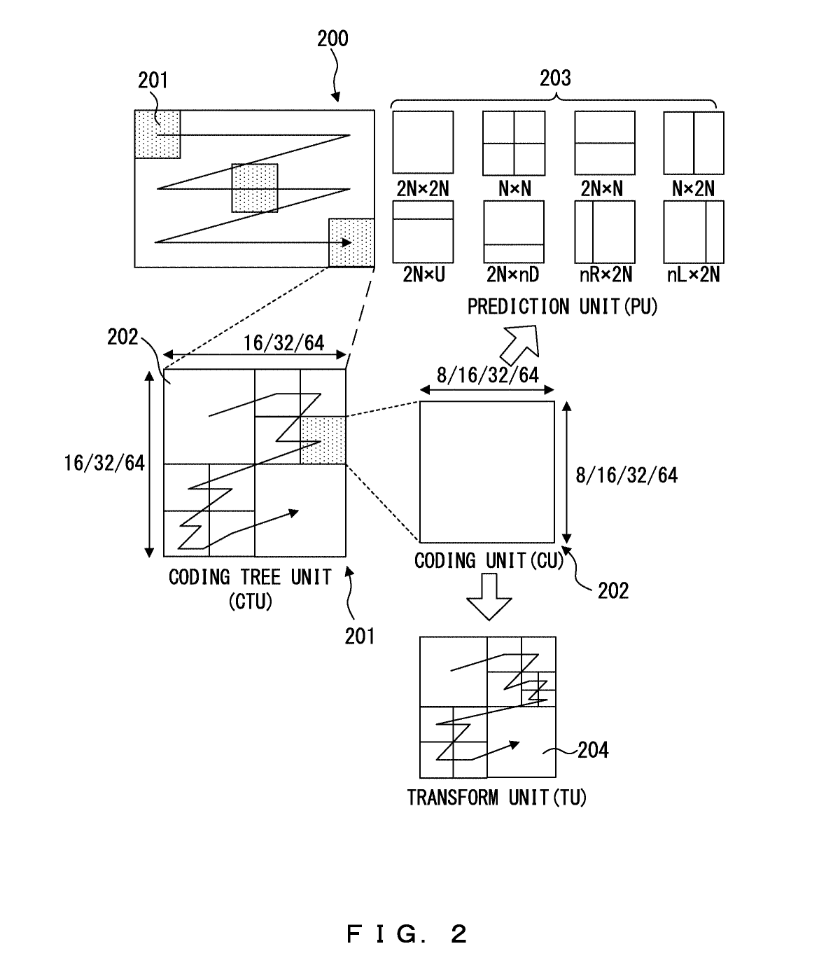

FIG. 2 illustrates an example of the division of a picture according to HEVC. As illustrated in FIG. 2, a picture 200 is divided in units of Coding Tree Units (CTUs), which are units in an encoding process, and each CTU 201 is encoded in the order of a raster scan. A size can be selected from a range of 64×64 pixels through 16×16 pixels as the size of the CTU 201.

The CTU 201 is further divided into a plurality of Coding Units (CUs) 202 in a quadtree structure. Each CU 202 in one CTU 201 is encoded in the order of a Z scan. The CU 202 has a variable size, and the size is selected from a range of 8×8 pixels through 64×64 pixels of a CU division mode. The CU 202 serves as a unit for selecting the intra-predictive encoding mode, the inter-predictive encoding mode, the palette encoding mode, or the map encoding mode as an encoding mode.

The CUs 202, when receiving intra-predictive encoding or inter-predictive encoding, are separately processed in units of Prediction units (PUs) 203 or Transform units (TUs) 204. The PU 203 serves as a unit for generating a prediction block, for which prediction is conducted in accordance with the encoding mode. For example, in the intra-predictive encoding mode, the PU 203 is a unit to which a predictive mode defining a pixel to be referred to in generating a prediction block and a generation method of a prediction block is applied. In the inter-predictive encoding mode, meanwhile, the PU 203 serves as a unit for performing motion compensation. The size of the PU 203 can be selected from among 2N×2N, N×N, 2N×N, N×2N, 2N×U, 2N×nD, nR×2N, and nL×2N (N is CU size/2) when for example the inter-predictive encoding mode is applied. The TU 204 serves as a unit for an orthogonal transform, and an orthogonal transform is performed for each TU. The size of the TU 204 is selected from a range of 4×4 pixels through 32×32 pixels. The TU 204 is divided in a quadtree structure, and is processed in the order of a Z scan. Note that a CU is an example of a block.

The video encoding device 1 encodes the CTUs of an encoding-target picture in the order of a raster scan. Hereinafter, each unit of the video encoding device 1 will be explained by using an example of a process for one CTU.

The map generation unit 11 generates a pixel value map for each CU and for each CU size that can be selected for an encoding-target CTU.

For a CU of interest, which is an example of an encoding-target block, the map generation unit 11 generates for example a pixel value map representing a spatial distribution of pixel values of the CU of interest by using the following expression, which represents a relationship between the position in the CU and a pixel value. Note that the pixel value map is expressed as a block having the same size as that of the CU of interest.

[Expression 1]

map(i,j)=a·i+b·j+c (1)

In the above expression, i is the horizontal coordinates in the CU of interest, and j is the vertical coordinates in the CU of interest. A, b, and c are coefficients. Map (i, j) is the value of the pixel at the coordinates (i, j) in the pixel value map. In the present embodiment, map (i, j) is expressed as a value including not only the luminance but also a color. When for example the pixel value map is expressed by RGB color coordinate system, map (i, j) includes a red (R) component, a green (G) component, and a blue (B) component. Also, when the pixel value map is expressed by YCrCb color coordinate system, map (i, j) includes a luminance component and two color-difference components.

The map generation unit 11 may calculate coefficients a, b, and c by applying for example a least-square approach to expression (1) for a CU of interest. Alternatively, the map generation unit 11 may use a trial-and-error method to obtain coefficients a, b, and c in such a manner that the most number of pixels have values that are identical to the values of the corresponding pixel in the pixel value map expressed by expression (1), from among the pixels in the CU of interest.

Alternatively, the map generation unit 11 may use a polynomial of second or higher degrees instead of expression (1) for coordinates (i, j) to generate a pixel value map. In such a case as well, the map generation unit 11 calculates the coefficients of the terms of a polynomial by using a least-square approach or a trial-and-error method similarly to the above case.

Alternatively, the map generation unit 11 may generate a pixel value map on the basis of the value of a pixel around the CU of interest. For example, the map generation unit 11 may generate a pixel value map in accordance with one of a plurality of predictive modes, defined by HEVC, for specifying a prediction direction in an intra-predictive encoding mode. In such a case, the pixel value map is encoded before the CU of interest, and is calculated by using a decoded pixel that is adjacent to the CU of interest on the upper or left side. Further, the value of each pixel of the pixel value map calculated on the basis of the value of a pixel around the CU of interest may be used as an off-set value. In such a case, the map generation unit 11 may treat a value as the value of the pixel at coordinates (i, j) in the pixel value map, the value resulting from for example adding the off-set value of the pixel at coordinates (i, j) calculated on the basis of the value of a pixel around the CU of interest to value map (i, j) of the pixel at coordinates (i, j) calculated by expression (1).

The map generation unit 11 reports, to the map encoding unit 13 and for each CU, information representing the generated pixel value map (for example coefficients a, b, c of expression (1)).

The palette table generation unit 12 generates a palette table for each CU and for each CU size that can be selected for an encoding-target CTU.

For each color entry registered in a palette table for a CU that has been palette encoded or map encoded immediately before the CU of interest, the palette table generation unit 12 determines whether the CU of interest includes a pixel having the same value (including a color component) as the value of that color entry. Note that a palette table used for a CU that has been palette encoded or map encoded immediately before the CU of interest will hereinafter be referred to as a previous palette table for the sake of convenience of the explanations. The palette table generation unit 12 thereafter adds a flag to a color entry including a pixel having the same value as that of the CU of interest from among the color entries in the previous palette table, the flag indicating that the entry will be reused. A color entry not including a pixel having the same value as that of the CU of interest is deleted.

Further, the palette table generation unit 12 registers values in a palette table in descending order of appearance frequency, the values belonging to pixels, in the CU of interest, not included in the previous palette table. When a previous palette table does not exist, the palette table generation unit 12 registers the values of pixels in a palette table in descending order of appearance frequency in the CU of interest without using flags indicating the reuse.

The palette table generation unit 12 assigns a different index to each of the color entries registered in the palette table for the CU of interest. It is desirable that the palette table generation unit 12 perform the assignment in such a manner that the higher the appearance frequency of a color entry is in the CU of interest, the shorter the index assigned to that color entry is. This increases the encoding efficiency. Alternatively, the palette table generation unit 12 may assign indexes in accordance with the positions of the color entries in the palette table. In such a case, the video decoding device can identify the color entry corresponding to an index even when encoded data does not include information representing an index corresponding to each color entry, leading to improved encoding efficiency.

The palette table generation unit 12 reports a palette table for each CU to the map encoding unit 13 and the palette encoding unit 14.

For each CU size that can be selected for an encoding-target CTU, the map encoding unit 13 performs encoding by referring to a pixel value map corresponding to each CU and in accordance with the map encoding mode.

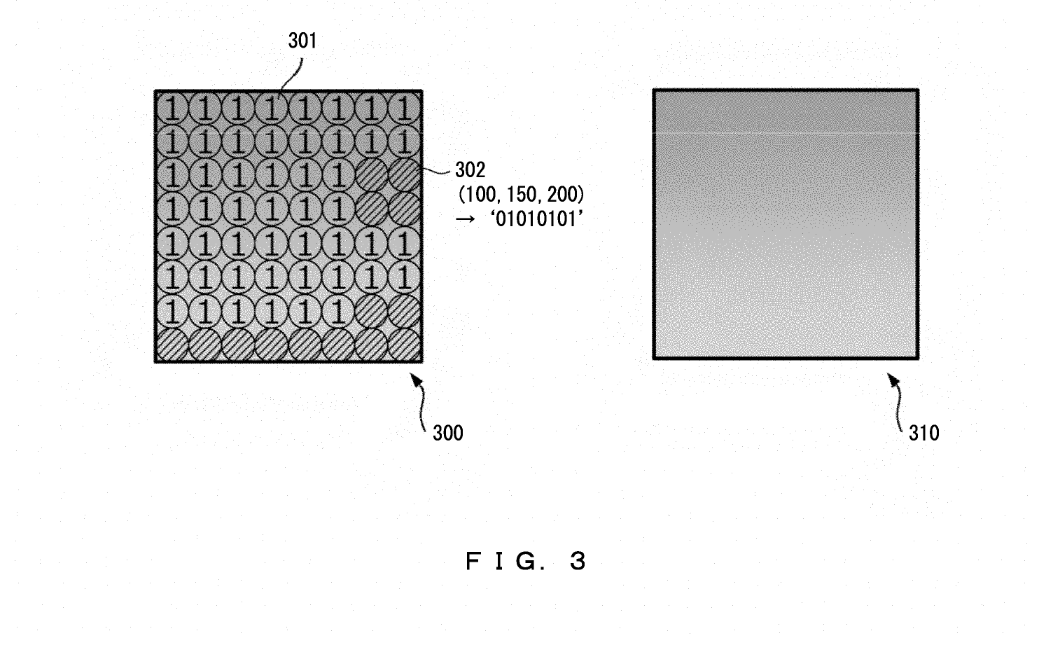

FIG. 3 illustrates an example of map encoding performed by referring to a pixel value map. The map encoding unit 13 compares the value of each pixel in a CU of interest 300 and the value of the corresponding pixel in a pixel value map 310. The map encoding unit 13 adds, for each pixel in the CU of interest 300, a flag indicating whether the value of that pixel and the value of the corresponding pixel in the pixel value map 310 are identical (the flag will hereinafter be referred to as an identicalness flag for the sake of convenience of the explanations). In the example illustrated in FIG. 3, identicalness flags having the value of “1” are added to pixels 301 having the same values as those of the corresponding pixels in the pixel value map 301. For the CU 300, the map encoding unit 13 also adds indexes of color entries, from among the color entries registered in the palette table of the CU 300, having the same values as those of pixels 302 that have values different from those of the corresponding pixels in the pixel value map 310. For example, when the value of the pixel 302 in the CU 300 is (100, 150, 200) in RGB color coordinate system and the index assigned to the color entry (100, 150, 200) in the palette table is “01010101”, the map encoding unit 13 specifies “01010101” for the pixel 302.

Note that when the CU 300 includes a pixel not identical to those in the pixel value map 310 as illustrated in FIG. 3, applying an intra-predictive encoding mode to the CU 300 does not always improve the encoding efficiency because of an increased prediction error between a prediction block and the CU 300. Also, dividing the CU 300 into CUs of smaller size and applying an intra-predictive encoding mode to each divisional CU does not always improve the encoding efficiency because of an increased amount of encoding caused by the division. In map encoding by contrast, a value of a pixel having a value different from the value of the corresponding pixel in the pixel value map is also expressed by an index, for which the amount of encoding is relatively small. This improves the encoding efficiency even when the CU 300 includes a pixel having a value different from the value of the corresponding pixel in the pixel value map.

The map encoding unit 13 reports the encoding result for each CU to the encoding mode determination unit 16.

For each CU size that can be selected for an encoding-target CTU, the palette encoding unit 14 performs encoding by referring to a palette table corresponding to each CU and in accordance with the palette encoding mode.

For each pixel in the CU of interest, the palette encoding unit 14 identifies a color entry in the palette table having the same value as the value of that pixel, and specifies the index of the identified color entry for that pixel. Next, the palette encoding unit 14 determines, for each pixel in the CU of interest, whether the index specified for that each pixel and the index specified for the pixel adjacent to that each pixel on the upper side are identical, in the order of a raster scan. The palette encoding unit 14 adds a copy flag to a pixel for which the same index as that specified for the pixel adjacent to that pixel on the upper side is specified, the copy flag indicating that the index is identical to that of the pixel adjacent on the upper side.

For the CU of interest, the palette encoding unit 14 also obtains a run length, which represents the number of pixels continuing in a portion including pixels that have the identical indexes specified for themselves in the order of a raster scan. The palette encoding unit 14 uses the obtained run length to express the value of the pixels of the portion including the pixels that have the identical indexes specified for themselves.

The palette encoding unit 14 reports the encoding result for each CU to the encoding mode determination unit 16.

For each CU size that can be selected for an encoding-target CTU and for each PU included in the CU, the prediction block generation unit 15 generates a prediction block for each predictive mode that is applicable as the inter-predictive encoding mode and the intra-predictive encoding mode. The prediction block generation unit 15 performs the same process for each color component or for each luminance component and color-difference component in the present embodiment, and accordingly explanations will hereinafter be given for a process for one component (a luminance component for example).

To generate a prediction block, the prediction block generation unit 15 calculates a motion vector for each PU that can be applied to an encoding-target CTU when an encoding-target picture including the encoding-target CTU is a P-picture or a B-picture, to which an inter-predictive encoding mode can be applied. Note that the type of an encoding-target picture is determined on the basis of for example the structure of Group Of Pictures (GOP) that a control unit (not illustrated) applies to video data as an encoding target and the position in GOP in the encoding-target picture.

The prediction block generation unit 15 performs block matching on an area that can be referred to for a local decoding picture for a PU of interest in the encoding-target CTU, and identifies a reference block that is identical to the PU of interest to the highest degree. Then, a prediction block generation unit calculates a vector representing the movement amount between the PU of interest and the reference block as a motion vector. Note that the prediction block generation unit 15 generates motion vectors for both L0 prediction and L1 prediction when the encoding-target picture is a B-picture.

The prediction block generation unit 15 performs, for each PU, motion compensation on a reference block in a local decoding picture on the basis of the calculated motion vector, and thereby generates a prediction block for inter-predictive encoding.

The prediction block generation unit 15 also generates, for each PU and for each predictive mode of intra-predictive encoding, a prediction block for intra-predictive encoding on the basis of the value of a pixel in a local decoding block around that PU and in accordance with that predictive mode.

For each CU and for each of the generated prediction blocks, the prediction block generation unit 15 reports, to the encoding mode determination unit 16, that prediction block, the encoding mode employed to generate that prediction block, the motion vector, the predictive mode, etc.

The encoding mode determination unit 16 determines a division mode of dividing an encoding-target CTU into CUs and an encoding mode employed for each CU. The encoding mode determination unit 16 further determines a PU division mode and a TU division mode for a CU to which the inter-predictive encoding mode or the intra-predictive encoding mode is applied.

The encoding mode determination unit 16 determines an encoding mode that can be applied to an encoding-target CTU on the basis of for example information representing the type of an encoding-target picture that includes that encoding-target CTU obtained from the control unit (not illustrated). When the type of the encoding-target picture is an I-picture, to which the inter-predictive encoding mode is not applied, the encoding mode determination unit 16 selects one of the map encoding mode, the palette encoding mode, and the intra-predictive encoding mode as an applicable encoding mode. When the type of the encoding-target picture is P-picture or B picture, the encoding mode determination unit 16 selects one of the map encoding mode, the palette encoding mode, the intra-predictive encoding mode, and the inter-predictive encoding mode as an applicable encoding mode.

The encoding mode determination unit 16 calculates an encoding cost for each CU, the encoding cost being an evaluation value of the amount of encoded data of the encoding-target CTU in an applicable encoding mode. For the inter-predictive encoding mode for example, the encoding mode determination unit 16 calculates an encoding cost for each combination between a CU division mode of dividing a CTU, a PU division mode, and a vector mode of defining a method of generating a prediction vector of a motion vector. The encoding mode determination unit 16 may use for example either the Adaptive Motion Vector Prediction (AMVP) mode or the Merge mode as a vector mode. The AMVP mode is a mode in which a difference vector is encoded by using a prediction vector, and the Merge mode is a mode in which a prediction vector obtained from a motion vector of an encoded PU is copied as a motion vector of an encoding-target PU.

For the intra-predictive encoding mode, the encoding mode determination unit 16 calculates an encoding cost for each combination between a CU division mode of dividing a CTU, a PU division mode, and a predictive mode.

To calculate encoding costs for an inter-predictive encoding mode and an intra-predictive encoding mode, the encoding mode determination unit 16 calculates for example a prediction error, i.e., the sum of absolute difference (SAD) for a pixel, in accordance with the following expression for each of the luminance components and the color components of the PU of interest.

SAD=Σ|OrgPixel−PredPixel|

In the above expression, OrgPixel is the value of a pixel included in the PU of interest, and PredPixel is the value of a pixel included in a prediction block that corresponds to the block of interest and that is generated in accordance with the encoding mode for which the encoding cost is calculated.

The encoding mode determination unit 16 then uses for example the following expression to calculate encoding cost Cost for each of the luminance components and the color components of the CU of interest.

Cost=ΣSAD+λ*B

In the above expression, SAD is the total of SAD calculated for each PU that is included in the CU of interest. Also, B is an estimated value of an encoding amount for an item, other than a prediction error, such as for example a motion vector and a flag representing a predictive mode. A is a Lagrange multiplier. The encoding mode determination unit 16 then determines the sum of the encoding cost calculated for each of the luminance components and the color components to be encoding costs of the CU of interest for the inter-predictive encoding mode and the intra-predictive encoding mode.

The encoding mode determination unit 16 may calculate, instead of the SAD, the sum of absolute transformed differences (SATD) of Hadamard coefficient of each pixel after the difference image between the PU of interest and the prediction block undergoes a Hadamard Transform.

The encoding mode determination unit 16 further calculates, as an encoding cost, the amount of information for encoding the CU of interest in the map encoding mode. In this case, the amount of the information is equal to the total of the amount of information for representing coefficients in expression (1), which expresses a pixel value map, the amount of information for representing a palette table, and the amount of information of an identicalness flag or index of each pixel in the CU of interest. Similarly, the encoding mode determination unit 16 calculates, as an encoding cost, the amount of information for encoding the CU of interest in the palette encoding mode. In this case, the amount of information is equal to for example the total of the amount of information for representing a palette table and the amount of information of an index, a copy flag or a run length of each pixel in the CU of interest.

The encoding mode determination unit 16 sets CUs of interest in the encoding-target CTU in for example descending order of size that can be selected as a CU size. The encoding mode determination unit 16 then selects a predictive mode that results in the minimum cost for each PU division mode in the CU of interest for the intra-predictive encoding mode. The encoding mode determination unit 16 also selects a vector mode that results in the minimum cost for each PU division mode in the CU of interest for the inter-predictive encoding mode. The encoding mode determination unit 16 further selects, for each group of CUs of the same size, an encoding mode that results in the minimum encoding cost from among the intra-predictive encoding mode, the inter-predictive encoding mode, the map encoding mode, and the palette encoding mode. The encoding mode determination unit 16 determines the selected encoding mode to be the encoding mode that is to be applied to the CU.

Further, the encoding mode determination unit 16 performs a similar process on a next CU of interest to calculate the minimum encoding cost, the next CU of interest being each of the four CUs obtained by dividing the CU of interest into four. When the total of the minimum encoding cost calculated for each of the four divisional CUs is smaller than the minimum encoding cost for the CU of interest, the encoding mode determination unit 16 divides the CU of interest into four. The encoding mode determination unit 16 repeats the above process until when each CU is not divided, and thereby determines a CU division mode to be applied to the encoding-target CTU. Also, when the intra-predictive encoding mode or the inter-predictive encoding mode is selected as an encoding mode to be applied, the encoding mode determination unit 16 selects the PU division mode corresponding to the minimum encoding cost as a PU division mode to be applied.

Further, the encoding mode determination unit 16 determines a TU division mode for each CU to which the intra-predictive encoding mode or the inter-predictive encoding mode is applied, from among the CUs determined in the CU division mode determined in the above manner. In this determination, the encoding mode determination unit 16 calculates RD cost Cost for each applicable TU division mode by using the following expression.

$$\begin{matrix}[ Expression 2 ] & \\ Cost = {\sum }_{i} {( org ( i ) - ldec ( i ) )}^{2} + λ \cdot bit & ( 2 )\end{matrix}$$

In the above expression, org (i) is the value of a pixel included in the CU of interest, and ldec (i) is the value of a decoded pixel, which is a result of encoding that CU of interest in the TU division mode of interest and decoding the encoded CU. Also, bit is the amount of encoding for encoding that CU in the TU division mode of interest. In expression (2), the first term in the right member is encoding distortion and the second term in the right member is an encoding amount. This leads to an optimum balance between the encoding distortion and the encoding amount in the TU division mode that results in the minimum RD cost. In this situation, the encoding mode determination unit 16 selects a TU division mode that results in the minimum RD cost Cost.

The encoding mode determination unit 16 reports, to the predictive encoding unit 17, a combination between the division modes and the encoding modes, for a CU, a PU, and a TU, selected for the encoding-target CTU. The encoding mode determination unit 16 also stores, in the storage unit 18, the combination between the division modes and the encoding modes, for a CU, a PU, and a TU, selected for the encoding-target CTU. Further, the encoding mode determination unit 16 reports, to the predictive encoding unit 17, the motion vector of a CU to which the inter-predictive encoding mode is applied, and stores that motion vector in the storage unit 18.

The encoding mode determination unit 16 also delivers, to the entropy encoding unit 19, a result of encoding a CU for which the palette encoding mode was selected and which was received from the palette encoding unit 14. Similarly, the encoding mode determination unit 16 delivers, to the entropy encoding unit 19, a result of encoding a CU for which the map encoding mode was selected and which was received from the map encoding unit 13. The encoding mode determination unit 16 further stores, in the storage unit 18, a CU resulting from decoding the result of encoding that CU (such as for example the index or identicalness flag of each pixel) and the palette table for that CU.

The predictive encoding unit 17 predictively encodes a CU to which the intra-predictive encoding mode or the inter-predictive encoding mode is applied, from among the CUs that are determined by the division modes of the CUs selected for the encoding-target CTU. For this purpose, the predictive encoding unit 17 generates, for the CU of interest, a prediction block for each PU in accordance with the combination between the division mode and the encoding mode for a selected PU. When the CU of interest is to receive intra-predictive encoding, the predictive encoding unit 17 generates a prediction block on the basis of the value of a pixel in a local decoding block around each PU that is referred to in accordance with the predictive mode selected for that PU in that CU of interest.

When the CU of interest is to receive inter-predictive encoding, the predictive encoding unit 17 performs, for each PU in that CU, motion compensation on a local decoding picture read from the storage unit 18, on the basis of the motion vector calculated for that PU, and thereby generates a prediction block.

When a prediction block has been generated, the predictive encoding unit 17 performs a difference operation between the prediction block and the corresponding pixel for each pixel in the CU of interest. The predictive encoding unit 17 determines the difference value that corresponds to each pixel in each TU in the CU of interest and that was obtained through the difference operation to be the prediction error signal of that TU.

For each TU in the CU of interest, the predictive encoding unit 17 orthogonally transforms the prediction error signal of that TU so as to obtain the orthogonal transform coefficients representing the horizontal and vertical frequency components of the prediction error signal. For example, the predictive encoding unit 17 performs a Discrete Cosine Transform (DCT) as an orthogonal transform process on the prediction error signal, and thereby obtains a set of DCT coefficients as an orthogonal transform coefficient.

The predictive encoding unit 17 quantizes the orthogonal transform coefficient of each TU in accordance with quantization parameters including a qp value, which specifies the quantization width, and thereby calculates a quantized orthogonal transform coefficient. Note hereinafter that a quantized orthogonal transform coefficient will be referred to simply as a quantization coefficient in some cases. The predictive encoding unit 17 outputs the quantized orthogonal transform coefficient to the entropy encoding unit 19.

The predictive encoding unit 17 further generates, from the quantization coefficient of each TU, a local decoding block that is referred to for encoding a CU etc. subsequent to that TU, and stores the local decoding block in the storage unit 18. Then, the predictive encoding unit 17 inversely quantizes the quantization coefficient that was quantized for each TU, and thereby restores the orthogonal transform coefficient before the quantization.

For each TU, the predictive encoding unit 17 performs an inverse orthogonal transform on the restored orthogonal transform coefficient. For example, when the predictive encoding unit 17 employs a DCT as an orthogonal transform, the predictive encoding unit 17 performs an inverse DCT process as an inverse orthogonal transform. Thereby, the predictive encoding unit 17 restores, for each TU, a prediction error signal having information at a level similar to that of the prediction error signal before being encoded.

For each TU, the predictive encoding unit 17 adds the restored prediction error signal to the value of each pixel of the prediction block of that TU, and thereby generates a local decoding block. Each time the predictive encoding unit 17 generates a local decoding block, the predictive encoding unit 17 stores that local decoding block in the storage unit 18.

Also, connecting local decoding blocks for one picture in the order of the encoding of the CTUs results in a local decoding picture. The local decoding picture is also stored in the storage unit 18.

The storage unit 18 temporarily stores a local decoding block received from the predictive encoding unit 17. The storage unit 18 supplies a local decoding picture or a local decoding block to the prediction block generation unit 15 or the predictive encoding unit 17. Note that the storage unit 18 stores a prescribed number of local decoding pictures that may be referred to by an encoding-target picture, and, when the number of such local decoding pictures exceeds the prescribed number, discards them starting from the oldest in the order of the encoding.

Further, the storage unit 18 stores the motion vector of each local decoding block that received inter-predictive encoding. The storage unit 18 also stores information representing the palette table for each palette-encoded CU and the pixel value map for each map-encoded CU. The storage unit 18 further stores a combination between the division modes and the encoding modes, for a CU, a PU, and a TU, selected for each CTU.

The entropy encoding unit 19 is an example of an adding unit, and entropy encodes the quantization coefficient, the motion vector, etc. of a CU to which the inter-predictive encoding mode or the intra-predictive encoding mode has been applied, from among the CUs in the encoding-target CTU. The entropy encoding unit 19 entropy encodes the index, the copy flag, the run length, the palette table, etc. of each pixel for a palette-encoded CU, from among the CUs in the encoding-target CTU. The entropy encoding unit 19 further entropy encodes information representing the pixel value map for a CU that has been map encoded, the identicalness flag or index of each pixel, etc., from among the CUs in the encoding-target CTU. The entropy encoding unit 19 further entropy encodes various types of syntaxes used for decoding the encoded CTU. The entropy encoding unit 19 then includes the data obtained through the entropy encoding, in a bit stream that represents an encoded video data.

As an entropy encoding method, the entropy encoding unit 19 in the present embodiment employs an arithmetic encoding process such as Context-based Adaptive Binary Arithmetic Coding (CABAC). The entropy encoding unit 19 outputs a bit stream obtained through entropy encoding.

Connecting, in a prescribed order, the bit streams of the CTUs output from the entropy encoding unit 19 and adding header information etc. defined by HEVC results in an encoded bit stream that includes encoded video data. The video encoding device 1 stores the encoded bit stream in a storage device (not illustrated) including a magnetic recording medium, an optical recording medium, a semiconductor memory, etc., or outputs the encoded bit stream to a different device.

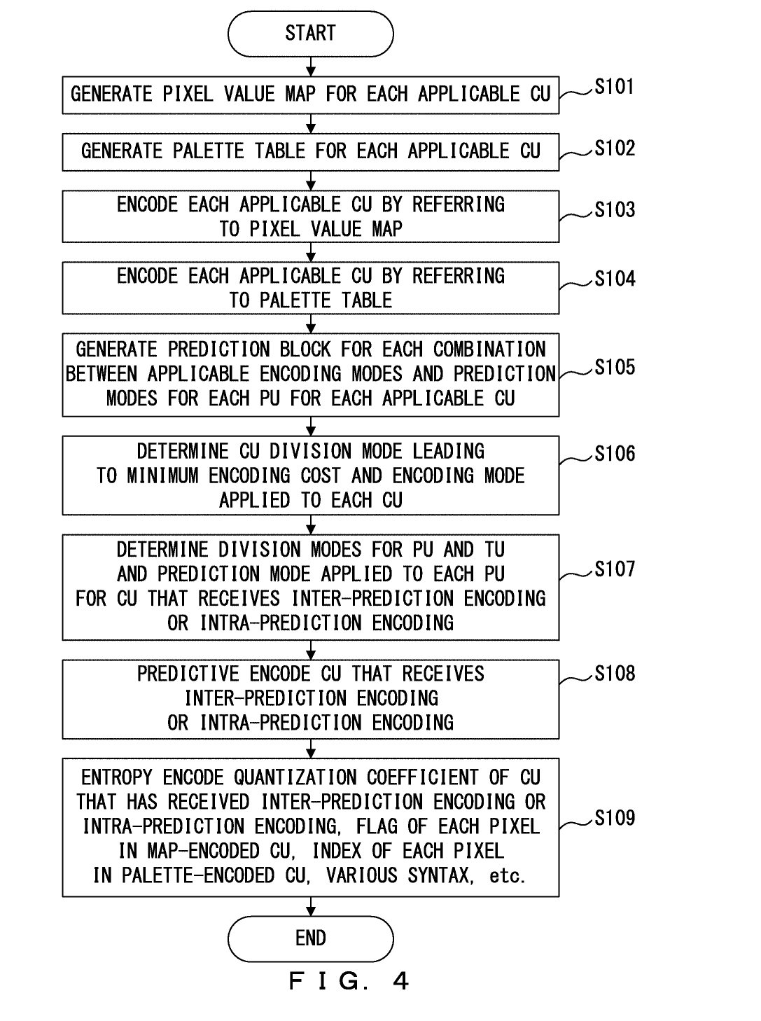

FIG. 4 illustrates an operation flowchart for a video encoding process performed by the video encoding device 1. The video encoding device 1 encodes each CTU in accordance with the operation flowchart explained below.

The map generation unit 11 generates a pixel value map for each CU and for each CU size that can be selected for an encoding-target CTU (step S101). The palette table generation unit 12 generates a palette table for each CU and for each CU size that can be selected for an encoding-target CTU (step S102).

The map encoding unit 13 refers to a pixel value map corresponding to each CU to encode the CUs for each CU size that can be selected for an encoding-target CTU (step S103). The map encoding unit 13 then reports the result of encoding each CU to the encoding mode determination unit 16.

The palette encoding unit 14 further encodes the CUs for each CU size that can be selected for an encoding-target CTU by referring to a palette table corresponding to each CU (step S104). The palette encoding unit 14 then reports the result of encoding each CU to the encoding mode determination unit 16.

For each CU size that can be selected for an encoding-target CTU and for each PU included in the CU, the prediction block generation unit 15 generates a prediction block for each predictive mode that is applicable as the inter-predictive encoding mode and the intra-predictive encoding mode (step S105). The prediction block generation unit 15 then reports each prediction block, the encoding mode used for generating that prediction block, etc. to the encoding mode determination unit 16.

On the basis of the results of the map encoding and the palette encoding on each CU and the prediction block for each encoding mode, the encoding mode determination unit 16 determines a division mode of dividing an encoding-target CTU into CUs and an encoding mode applied to each CU (step S106). In the determination, the encoding mode determination unit 16 determines a division mode for a CU and an encoding mode applied to each CU in such a manner that the encoding cost is the minimum. Further, the encoding mode determination unit 16 determines a PU division mode, a TU division mode and a predictive mode to be applied, for a CU to which the inter-predictive encoding mode or the intra-predictive encoding mode is applied (step S107). From among the CUs determined in accordance with a division mode for a CU selected for the encoding-target CTU, the encoding mode determination unit 16 then reports, to the predictive encoding unit 17, a CU to which the intra-predictive encoding mode or the inter-predictive encoding mode is applied and the encoding mode to be applied to that CU. For a CU for which the palette encoding mode has been selected from among the CUs determined in accordance with a division mode for a CU selected for the encoding-target CTU, the encoding mode determination unit 16 further delivers, to the entropy encoding unit 19, the result of encoding that CU received from the palette encoding unit 14. Similarly, for a CU for which the map encoding mode has been selected, the encoding mode determination unit 16 delivers, to the entropy encoding unit 19, the result of encoding that CU received from the map encoding unit 13.

The predictive encoding unit 17 predictively encodes a CU to which the intra-predictive encoding mode or the inter-predictive encoding mode is applied, from among the CUs determined in accordance with a division mode for a CU selected for the encoding-target CTU (step S108). In doing so, the predictive encoding unit 17 quantizes an orthogonal transform coefficient that is obtained by performing an orthogonal transform on the prediction error of each pixel in the CU in units of TUs.

The entropy encoding unit 19 entropy encodes the quantization coefficient of each CU that has been predictively encoded, the identicalness flag of each pixel in each map-encoded CU, the index of the color entry of each pixel in each palette-encoded CU, various syntaxes, etc. (step S109). Thereby, the entropy encoding unit 19 generates an encoded bit stream of the encoding-target CTU. The entropy encoding unit 19 outputs the obtained encoded bit stream. The video encoding device 1 then terminates the video encoding process.

As described above, this video encoding device generates a pixel value map representing a distribution of the pixel values of the entire block as an encoding target. Thereby, even when a block as an encoding target involves a diagonal gradation, a pixel value map represents a distribution of the pixel values of that block. The video encoding device also obtains, for each pixel of that block, an identicalness flag indicating whether the value of that pixel is identical to the value of the corresponding pixel, and includes that identicalness flag in the encoded video data. This makes it possible to improve the efficiency in encoding video data even when the video data includes a picture involving a diagonal gradation. Also, this video encoding device encodes a pixel having a value different from the value of the corresponding pixel in the pixel value map by using the index of the corresponding color entry in the palette table, from among the pixels in an encoding-target block. This makes it possible for the video encoding device to improve the encoding efficiency even when a pixel value map fails to express the values of all the pixels in an encoding-target block.

Next, explanations will be given for a video decoding device configured to decode video data that has been encoded by the above video encoding device.

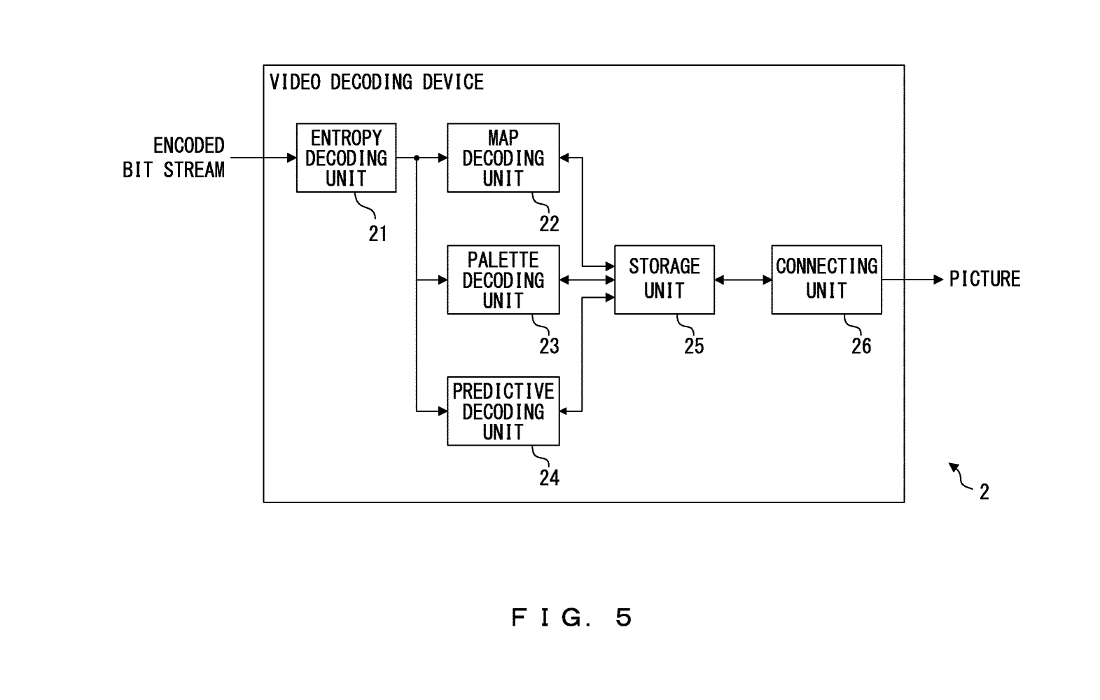

FIG. 5 schematically illustrates a configuration of a video decoding device according to an embodiment. The video decoding device 2 includes an entropy decoding unit 21, a map decoding unit 22, a palette decoding unit 23, a predictive decoding unit 24, a storage unit 25, and a connecting unit 26. Each of the units belonging to the video decoding device 2 is formed as a separate circuit. Alternatively, the units belonging to the video decoding device 2 may be mounted on the video decoding device 2 as an integrated circuit in which circuits corresponding to the units are integrated. Further, the units belonging to the video decoding device 2 may be function modules that are implemented by a computer program executed on a processor included in the video decoding device 2.

The video decoding device 2 obtains an encoded bit stream including encoded video data through for example a communication network and an interface circuit that is for connecting the video decoding device 2 to the communication network. The video decoding device 2 stores that encoded bit stream in a buffer memory (not illustrated). The video decoding device 2 reads the encoded data from the buffer memory in units of CTUs, and inputs the data in units of CTUs to the entropy decoding unit 21.

The entropy decoding unit 21 is an example of a separation unit, and entropy decodes data that has been encoded in units of CTUs. The entropy decoding unit 21 entropy decodes various types of syntaxes so as to extract the syntaxes, the various types of syntaxes including syntaxes representing a division mode and an encoding mode that were applied. The entropy decoding unit 21 also entropy decodes the quantization coefficient of each CU that has received the intra-predictive encoding or the inter-predictive encoding in the CTU. The entropy decoding unit 21 further entropy decodes information, such as for example the applied vector mode, about the predictive mode for each PU included in each CU that has received the intra-predictive encoding and the motion vector of each CU that has received the inter-predictive encoding.

For each CU to which the map encoding mode has been applied, the entropy decoding unit 21 further entropy decodes information representing the pixel value map, information representing the palette table, the identicalness flag of each pixel, etc. The entropy decoding unit 21 further entropy decodes information representing the palette table, the index, copy flag and run length specified for each pixel, etc., for each CU to which the palette encoding mode has been applied.

The entropy decoding unit 21 delivers information about the motion vector, the predictive mode of the intra-predictive encoding, division modes for a CU, a PU, and a TU, the quantization coefficient, etc. to the predictive decoding unit 24. The entropy decoding unit 21 also delivers a division mode for a CU, information representing a pixel value map for each CU to which the map encoding mode has been applied, information representing a palette table, an identicalness flag or index of each pixel, etc. to the map decoding unit 22. The entropy decoding unit 21 further delivers a division mode for a CU, information representing the palette table of each CU to which the palette encoding mode has been applied, the index, copy flag and run length specified for each pixel, etc. to the palette decoding unit 23.

The map decoding unit 22 decodes CUs to which the map encoding mode has been applied. For this purpose, the map decoding unit 22 reproduces a pixel value map for the CU of interest by using the information representing the pixel value map of that CU. Note that the information representing the pixel value map is for example coefficients a, b, and c in expression (1). Alternatively, when a pixel value map is generated on the basis of the value of a decoded pixel around the CU of interest, the information representing the pixel value map is the value of the decoded pixel around the CU of interest.

The map decoding unit 22 further generates, for the CU of interest, a palette table by using information representing the palette table of that CU. The information representing a palette table includes for example a flag indicating whether to reuse a color entry for the immediately previous palette table that has been palette encoded or map encoded, and also includes a color entry newly registered for the CU of interest. Further, information representing a palette table may include an index corresponding to each color entry. Similarly to the palette table generation unit 12 of the video encoding device 1, the map decoding unit 22 then reproduces the palette table of the CU of interest on the basis of the color entry of the previous palette table to be reused and a newly registered color entry. In doing so, the map decoding unit 22, when information representing a decoded palette includes an index for each color entry, may refer to that information so as to determine the index for each color entry. Alternatively, the map decoding unit 22 may identify the index of each color entry in accordance with the order of registration of the color entries in the palette table.

When the pixel value map and the palette table are reproduced, the map decoding unit 22 refers to the identicalness flag of each pixel in the CU of interest. When the identicalness flag of the pixel of interest is identical to the value of the corresponding pixel in the pixel value map, the map decoding unit 22 determines the value of the corresponding pixel in the pixel value map to be the value of the pixel of interest.

When the index of a color entry has been specified for the pixel of interest, the map decoding unit 22 determines, to be the value of the pixel of interest, the value of the color entry, registered in the palette table, that corresponds to that index.

The map decoding unit 22 stores the decoded CU in the storage unit 25.

The palette decoding unit 23 decodes a CU to which the palette encoding mode has been applied. For this purpose, the palette decoding unit 23 reproduces, for the CU of interest, the palette table by using the information representing the palette table of that CU similarly to the map decoding unit 22.

The palette decoding unit 23 refers to the palette table, identifies, for each pixel in the CU of interest, the color entry corresponding to the index specified for that pixel, and determines the value of the identified color entry to be the value of that pixel. Also, for a pixel to which a copy flag indicating the specification of an index identical to the index of the pixel adjacent to that pixel on the upper side has been added, the palette decoding unit 23 determines the value of the pixel adjacent on the upper side to be the value of that pixel. Further, for a portion to which a run length has been added, the palette decoding unit 23 determines the value of the pixel immediately before that portion in the order of a raster scan to be the value of each pixel included in that portion having a length equivalent to the run length, the run length indicating the continuation of pixels for which identical indexes have been specified.

The palette decoding unit 23 stores the decoded CU in the storage unit 25.

The predictive decoding unit 24 decodes a CU that has received the inter-predictive encoding or the intra-predictive encoding.

The predictive decoding unit 24 then reproduces, for each PU in the CU that has received the inter-predictive encoding, a motion vector from information representing the decoded motion vector (for example, the applied vector mode, information representing the prediction vector, and the difference vector).

The predictive decoding unit 24 then refers to a decoded area in a decoded picture or a decoding-target picture, and generates, for each CU, a prediction block of each PU included in that CU. In doing so, the predictive decoding unit 24 performs a process similar to that performed by the prediction block generation unit 15 of the video encoding device 1 so as to generate a prediction block. When the CU of interest has received the inter-predictive encoding for example, the predictive decoding unit 24 performs, for each PU in that CU, motion compensation on a decoded picture read from the storage unit 25 on the basis of the motion vector decoded for that PU, and thereby generates a prediction block. Alternatively, when the CU of interest has received the intra-predictive encoding, the predictive decoding unit 24 generates, for each PU in that CU, a prediction block on the basis of the value of the decoded adjacent pixel read from the storage unit 25 and the predictive mode applied to that PU.

For the CU of interest, the predictive decoding unit 24 performs inverse quantization by multiplying a prescribed number by a quantization coefficient received from the entropy decoding unit 21, the prescribed number being equivalent to the quantization width determined by a quantization parameter obtained from the decoded header information. This inverse quantization restores the orthogonal transform coefficient. The predictive decoding unit 24 thereafter performs an inverse orthogonal transform process on an orthogonal transform coefficient for each TU in the CU of interest. Performing the inverse quantization process and the inverse orthogonal transform process on the quantization coefficient of each TU reproduces the prediction error signal of each pixel of the entire CU of interest.

The predictive decoding unit 24 adds, to the value of each pixel in the prediction block of each PU in the CU of interest, the reproduced prediction error signal corresponding to that pixel, and thereby can decode that PU. The predictive decoding unit 24 then connects the decoded PUs in the order of encoding, and thereby decodes the CU of interest. The predictive decoding unit 24 stores the decoded CU in the storage unit 25.

The storage unit 25 temporarily stores decoded CUs and decoded pictures received from the map decoding unit 22, the palette decoding unit 23, and the predictive decoding unit 24. The storage unit 25 also supplies, to the predictive decoding unit 24, a decoded CU as a reference area or a decoded picture as a reference picture. The storage unit 25 further supplies the motion vector of a decoded PU to the predictive decoding unit 24. The storage unit 25 further supplies the palette table of a decoded CU to the map decoding unit 22 and the palette decoding unit 23. Note that the storage unit 25 stores a prescribed number of pictures, and discards them in the order starting from the oldest picture in the encoding order when the amount of the stored data exceeds the amount equivalent to that prescribed number.

For each CTU, the connecting unit 26 connects the decoded CUs that are included in that CTU, in accordance with the CU division mode so as to decode that CTU, the CUs being stored in the storage unit 25. The connecting unit 26 further decodes the entire picture by connecting the decoded CTUs in accordance with the encoding order. The connecting unit 26 stores the decoded picture in the storage unit 25, and also stores the decoded picture in a buffer memory (not illustrated). Each decoded picture that is stored in the buffer memory is output by for example a control unit (not illustrated) to a display device (not illustrated) in accordance with the display order.

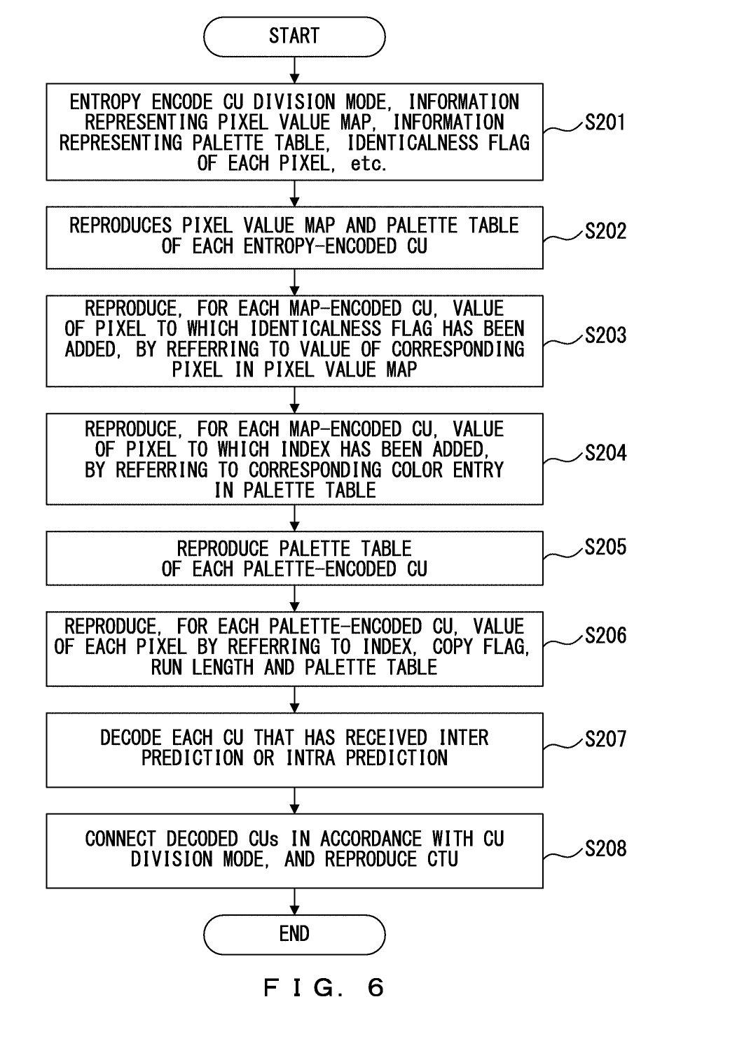

FIG. 6 illustrates an operation flowchart for a video decoding process performed by the video decoding device 2. The video decoding device 2 performs the video decoding process, illustrated in FIG. 6, for each decoding-target CTU. The entropy decoding unit 21 entropy decodes data that has been encoded in units of CTUs (step S201). Thereby, the CU division mode applied to a decoding-target CTU and the quantization coefficient of each CU that has received the inter-predictive encoding or the intra-predictive encoding are reproduced. Information representing the identicalness flag and pixel value map of each pixel in each map-encoded CU, information representing the index and palette table of each pixel in each palette-encoded CU, various types of syntaxes, etc. are further reproduced.

The map decoding unit 22 reproduces the pixel value map and palette table of each CU to which the map encoding mode has been applied (step S202). By referring to the value of the corresponding pixel in the pixel value map, the map decoding unit 22 then reproduces the value of each pixel to which an identicalness flag is added, for each CU to which the map encoding mode has been applied (step S203). The map decoding unit 22 also reproduces, for each CU to which the map encoding mode has been applied, the value of each pixel to which an index is added by referring to the corresponding color entry in the palette table (step S204). Thereby, the map decoding unit 22 decodes each CU to which the map encoding mode has been applied.

The palette decoding unit 23 also reproduces the palette table of each CU to which the palette encoding mode has been applied (step S205). The palette decoding unit 23 then refers to, for each CU to which the palette encoding mode has been applied, the index, copy flag, run length and palette table of each pixel in the CU to reproduce the value of each pixel in the CU, and thereby decodes the CU (step S206).

The predictive decoding unit 24 further decodes each CU to which the inter-predictive encoding or the intra-predictive encoding has been applied (step S207).

The connecting unit 26 connects the decoded CUs in accordance with the CU division mode, and thereby reproduces the decoding-target CTU (step S208). The connecting unit 26 stores the reproduced CTU in the storage unit 25. The video decoding device 2 then terminates the video decoding process for the decoding-target CTU.

As described above, the present video decoding device can decode encoded video data even when the data includes a block that has been map encoded by the video encoding device according to the above embodiment.

Note that one of the plurality of methods of generating a pixel value map may be selected in a variation example. For example, the map generation unit 11 of the video encoding device 1 may generate a pixel value map through expression (1) or may generate a pixel value map through one of the predictive modes for intra-predictive encoding. In that case, the map generation unit 11 calculates for example the error sums of squares between each pixel in the CU of interest and the corresponding pixel in the generated pixel value map for each method of generating a pixel value map, and employs a generation method that leads to a minimum error sum of squares. Alternatively, the map generation unit 11 employs a generation method that leads to the maximum number of pixels in the CU of interest having values identical to those of the corresponding pixels in the pixel value map.

The entropy encoding unit 19 of the video encoding device 1 then includes, in a bit stream representing an encoded video data, a syntax that represents the method of generating a pixel value map applied to each CU to which the map encoding mode has been applied.

The map decoding unit 22 of the video decoding device 2 also identifies a method of generating a pixel value map by referring to a syntax representing a method of generating the pixel value map that has been applied to each CU to which the map encoding mode has been applied, and thereby reproduces the pixel value map.

Note that a method of generating a pixel value map may be set for each CU as described above, for each CTU, for each slice or tile defined by HEVC, or for each picture.

According to another variation example, when indexes of the same color entry are added to the pixel of interest and the pixel adjacent on the upper side, the map encoding unit 13 of the video encoding device 1 may represent the value of the pixel of interest by a copy flag similarly to the palette encoding unit 14. Also, when the CU of interest includes a portion in which pixels having the same indexes added to themselves continue in the order of a raster scan, the map encoding unit 13 may use a run length to represent the value of each of the pixels included in that portion, similarly to the palette encoding unit 14. The map decoding unit 22 of the video decoding device 2 in that case reproduces the values of a pixel to which a copy flag has been added and each pixel included in the portion to which a run length has been added.

Note that a configuration may be employed in which the map encoding unit 13 uses a copy flag when the encoding cost is smaller when a copy flag is used than when it is not used. Similarly, a configuration may be employed in which the map encoding unit 13 uses a copy flag when the encoding cost is smaller when a run length is used than when a run length is not used.

Also, a CU of interest may sometimes include a pixel whose value is different from that of the corresponding pixel in the pixel value map and is also different from any color entries in the palette table. In such a case, the map encoding unit 13 may specify, for that pixel, the index of the color entry closest to the value of that pixel. Also, when a difference is within a prescribed range between the value of a pixel whose value is different from the value of the corresponding pixel in the pixel value map and is also different from any color entries in the palette table and the value of the corresponding pixel in the pixel value map, the map encoding unit 13 may add an identicalness flag to that pixel. In such a case, a CU obtained by decoding and the original CU are not completely identical. In such a case, the encoding mode determination unit 16 of the video encoding device 1 calculates for example the encoding cost for a case where the map encoding mode is applied in accordance with expression (2), and compares the calculated encoding cost with an encoding cost for a case where a different encoding mode is applied. In such a case, however, ldec (i) of the first term in the right member of expression (2) is the value of a decoded pixel that is obtained by decoding an encoded CU through map encoding.

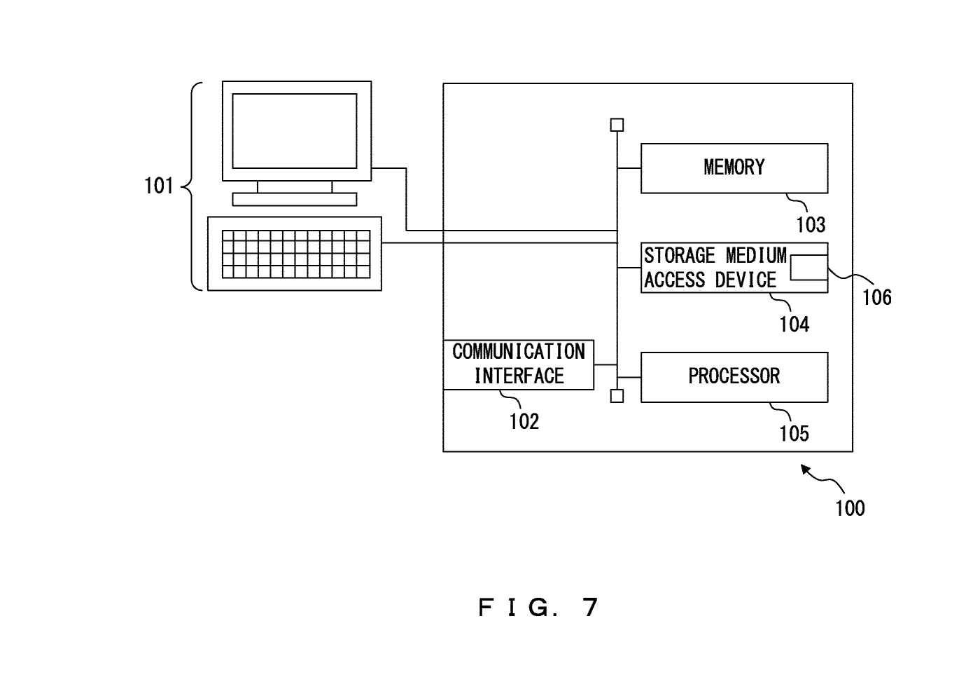

FIG. 7 illustrates a configuration of a computer that operates as a video encoding device or a video decoding device with a computer program operating for implementing the functions of the respective units of the video encoding device or the video decoding device according to the above embodiment or variation examples. This computer can be used for example as a server that generates a screen image in a system for implementing Wireless display or Virtual Desktop Infrastructure (VDI) or as a terminal device that reproduces an encoded screen image.

A computer 100 includes a user interface 101, a communication interface 102, a memory 103, a storage medium access device 104, and a processor 105. The processor 105 is connected to the user interface 101, the communication interface 102, the memory 103, and the storage medium access device 104 through for example a bus.

The user interface 101 includes for example an input device such as a keyboard, a mouse, etc., and a display device such as a liquid crystal display. Also, the user interface 101 may include a device, such as a touch panel display, that integratedly includes an input device and a display device. The user interface 101 for example outputs to the processor 105 a manipulation signal for selecting video data to encode or video data to decode, in response to a manipulation made by the user. Note that an application program operating on the processor 105 may determine video data to encode or video data to decode.

The communication interface 102 includes for example a communication interface, and a control circuit for the interface, for connecting to a communication network based on a communication standard such as Ethernet (registered trademark). The communication interface 102 obtains video data to encode from a different device that is connected to the communication network, and delivers that data to the processor 105. The communication interface 102 may also output encoded video data received from the processor 105 to a different device via the communication network. The communication interface 102 may also obtain a bit stream including encoded video data that is to be decoded, from a different device connected to the communication network, and deliver that bit stream to the processor 105.

The memory 103 is an example of a storage unit, and includes for example a random-access semiconductor memory and a read-only semiconductor memory. The memory 103 stores a computer program for implementing a video encoding process or a computer program for implementing a video decoding process, the computer programs being executed on the processor 105. The memory 103 also stores data generated during the video encoding process or the video decoding process or generated as a result of such a process.

The storage medium access device 104 is another example of a storage unit, and is for example a device, such as a magnetic disk, a semiconductor memory card, and an optical storage medium, that accesses the storage medium 106. The storage medium access device 104 reads for example a computer program for the video encoding process or a computer program for the video decoding program, and delivers the read program to the processor 105, the programs being stored in the storage medium 106 and executed on the processor 105.

The processor 105 includes a least one of for example a Central Processing Unit (CPU), a Graphics Processing Unit (GPU), and a numerical processor. The processor 105 also executes a computer program for the video encoding process according to the above embodiment or variation examples, and thereby encodes video data. The processor 105 then stores the encoded video data in the memory 103 or outputs the encoded video data to a different device via the communication interface 102. Alternatively, the processor 105 decodes the encoded video data by executing a computer program for the video decoding process according to the above embodiment or variation examples. The processor 105 then makes a display device of the user interface 101 display the decoded picture.

Note that a computer program for the video encoding process and a computer program for the video decoding process according to the above embodiment or variation examples may be provided in a form in which they are recorded in a computer-readable medium. However, such a medium does not include a carrier wave.

The above embodiment can improve the encoding efficiency even when video data includes a picture that involves a diagonal gradation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A video encoding device that encodes an encoding-target picture included in video data, the video encoding device comprising
a processor configured to
generate a pixel value map representing a spatial distribution of pixel values of an encoding-target block from among a plurality of blocks obtained by dividing the encoding-target picture,
add a flag to a pixel having a value identical to a value of a corresponding pixel in the pixel value map from among pixels included in the encoding-target block, and
include, in encoded data of the video data, information representing the pixel value map and the flag added to the pixel having a value identical to a value of a corresponding pixel in the pixel value map from among the pixels included in the encoding-target block.

2. The video encoding device according to claim 1, wherein
the processor further generates a palette table in which values of a plurality of pixels included in the encoding-target block are registered and which is associated with a different index for each of the values of the plurality of pixels;
in the adding of the flag, the processor adds, to a pixel having a value different from a value of a corresponding pixel in the pixel value map from among the pixels included in the encoding-target block, the index corresponding to a value identical to a value of that pixel having a value different from a value of a corresponding pixel in the pixel value map, from among values of the plurality of pixels registered in the palette table; and
in the including in the encoded data, the processor further includes, in the encoded data, information representing the palette table and the index added to a pixel having a value different from a value of a corresponding pixel in the pixel value map from among the pixels included in the encoding-target block.

3. The video encoding device according to claim 1, wherein
in the generating of the pixel value map, the processor generates the pixel value map on the basis of an expression that represents a relationship between a position in the encoding-target block and a pixel value.

4. The video encoding device according to claim 1, wherein
in the generating of the pixel value map, the processor generates the pixel value map by referring to a value of an encoded pixel around the encoding-target block.

5. The video encoding device according to claim 1, wherein
in the generating of the pixel value map, the processor generates the pixel value map in accordance with a method that leads to a minimum error between the pixel value map and the encoding-target block from among a plurality of methods of generating the pixel value map, and
in the including in the encoded data, the processor further includes, in the encoded data, information representing a method used for generating the pixel value map for the encoding-target block from among the plurality of methods.

6. A video decoding device that decodes a decoding-target picture included in video data, the video decoding device comprising
a processor configured to
extract, from encoded data of the video data, information representing a pixel value map that represents a spatial distribution of pixel values of a decoding-target block of the decoding-target picture and a flag added to a pixel having a value identical to a value of a corresponding pixel in the pixel value map from among pixels in the decoding-target block,
decode the pixel value map on the basis of the information representing the pixel value map, and
decode the decoding-target block on the basis of the decoded pixel value map and the flag.

7. The video decoding device according to claim 6, wherein
in the extracting, the processor further extracts, from the encoded data, information representing a palette table in which values of a plurality of pixels included in the decoding-target block are registered and which is associated with a different index for each of the values of the plurality of pixels and the index added to a pixel having a value different from a value of a corresponding pixel in the pixel value map from among the pixels included in the decoding-target block; and
in the decoding, the processor decodes the palette table on the basis of the information representing the palette table and decodes a value of a pixel having a value different from a value of a corresponding pixel in the pixel value map from among pixels in the decoding-target block, on the basis of the index added to that pixel having a value different from a value of a corresponding pixel in the pixel value map and on the basis of the palette table.

8. The video decoding device according to claim 6, wherein
the information representing the pixel value map is information that identifies an expression representing a relationship between a position in the decoding-target block and a pixel value.

9. The video decoding device according to claim 6, wherein
the information representing the pixel value map is a value of a decoded pixel around the decoding-target block.

10. The video decoding device according to claim 6, wherein
in the extracting, the processor further extracts, from the encoded data, information representing a method used for generating the pixel value map for the decoding-target block from among a plurality of methods of generating the pixel value map, and
in the decoding, the processor decodes the pixel value map in accordance with the information representing the method used for generating the pixel value map.

11. A video encoding method, performed by a computer, for encoding an encoding-target picture included in video data, the video encoding method comprising:
generating, by a processor, a pixel value map representing a spatial distribution of pixel values of an encoding-target block from among a plurality of blocks obtained by dividing the encoding-target picture;
adding, by the processor, a flag to a pixel having a value identical to a value of a corresponding pixel in the pixel value map from among pixels included in the encoding-target block; and
including, by the processor and in encoded data of the video data, information representing the pixel value map and the flag added to the pixel having a value identical to a value of a corresponding pixel in the pixel value map from among the pixels included in the encoding-target block.

12. A non-transitory computer-readable recording medium having stored therein a video encoding program for causing a computer to execute a process that encodes an encoding-target picture included in video data, the process comprising:
generating a pixel value map representing a spatial distribution of pixel values of an encoding-target block from among a plurality of blocks obtained by dividing the encoding-target picture;
adding a flag to a pixel having a value identical to a value of a corresponding pixel in the pixel value map from among pixels included in the encoding-target block; and
including, in encoded data of the video data, information representing the pixel value map and the flag added to the pixel having a value identical to a value of a corresponding pixel in the pixel value map from among the pixels included in the encoding-target block.

13. A video decoding method, performed by a computer, for decoding a decoding-target picture included in video data, the video decoding method comprising:
extracting, by a processor and from encoded data of the video data, information representing a pixel value map that represents a spatial distribution of pixel values of a decoding-target block of the decoding-target picture and a flag added to a pixel having a value identical to a value of a corresponding pixel in the pixel value map from among pixels in the decoding-target block;
decoding, by the processor, the pixel value map on the basis of the information representing the pixel value map; and
decoding, by the processor, the decoding-target block on the basis of the decoded pixel value map and the flag.

14. A non-transitory computer-readable recording medium having stored therein a video decoding program for causing a computer to execute a process that decodes a decoding-target picture included in video data, the process comprising:
extracting, from encoded data of the video data, information representing a pixel value map that represents a spatial distribution of pixel values of a decoding-target block of the decoding-target picture and a flag added to a pixel having a value identical to a value of a corresponding pixel in the pixel value map from among pixels in the decoding-target block;
decoding the pixel value map on the basis of the information representing the pixel value map; and
decoding the decoding-target block on the basis of the decoded pixel value map and the flag.
